(19) United States
(12) Patent Application Publication
(10) Pub. No.: US 2026/0312056 A1
(43) Pub. Date: Oct. 8, 2026

(54) SOLID-STATE LITHIUM-SULFUR BATTERY

(71) Applicant: TOYOTA JIDOSHA KABUSHIKI KAISHA, Toyota-shi (JP)

(72) Inventors: Ryo ASAKURA, Shizuoka-ken (JP); Shinya SHIOTANI, Nagoya-shi (JP)

(73) Assignee: TOYOTA JIDOSHA KABUSHIKI KAISHA, Toyota-shi (JP)

(21) Appl. No.: 19/539,375

(22) Filed: Feb. 13, 2026

(30) Foreign Application Priority Data
Apr. 8, 2025 (JP) 2025-063874

(51) Int. Cl. H01M 4/62; H01M 4/02

(52) U.S. Cl. CPC H01M 4/622; H01M 4/62; H01M 2004/021; H01M 2004/028

(57) ABSTRACT

A solid-state lithium-sulfur battery includes a positive electrode current collector layer, a positive electrode active material layer, a solid electrolyte layer, and a negative electrode current collector layer in this order. The positive electrode active material layer contains a sulfur-based active material, a solid electrolyte, and a resin binder that binds them to each other, the resin binder is butadiene rubber not containing fluorine, and a content of the resin binder in the positive electrode active material layer is more than 0.0% by mass and 0.5% by mass or less.

### CROSS-REFERENCE TO RELATED APPLICATION

This application claims priority to Japanese Patent Application No. 2025-063874 filed on Apr. 8, 2025. The disclosure of the above-identified application, including the specification, drawings, and claims, is incorporated by reference herein in its entirety.

### BACKGROUND

### 1. Technical Field

The present disclosure relates to a solid-state lithium-sulfur battery, particularly to a solid-state lithium metal-sulfur battery.

### 2. Description of Related Art

A solid-state lithium-sulfur battery is a secondary battery that contains a solid electrolyte as an electrolyte and uses a sulfur-based active material as a positive electrode active material. Since such a solid-state lithium-sulfur battery uses a solid electrolyte as an electrolyte, its performance such as charging performance is higher than that of a liquid-state battery using only a liquid electrolyte as an electrolyte. Further, since such a solid-state lithium-sulfur battery uses a sulfur-based active material as a positive electrode active material, its energy density is high.

A solid-state lithium metal-sulfur battery is a secondary battery containing a solid electrolyte as an electrolyte and using a sulfur-based active material as a positive electrode active material, in which a metallic lithium deposition and dissolution reaction occurs at a negative electrode during charging and discharging. Such a solid-state lithium metal-sulfur battery has, in addition to the effect of the solid-state lithium-sulfur battery described above, a high energy density due to a metallic lithium deposition and dissolution reaction that occurs at a negative electrode during charging and discharging.

In relation to such a solid-state lithium-sulfur battery, Japanese Unexamined Patent Application Publication No. 2020-119761 A (JP 2020-119761 A) discloses a method for producing a positive electrode for an all-solid-state lithium-sulfur battery, the method including the step of forming a positive electrode active material layer by applying a positive electrode slurry containing a positive electrode active material, a solid electrolyte, a binder, and a solvent onto a positive electrode current collector, wherein the positive electrode active material contains sulfur and the solvent has a donor number of 19 or less.

### SUMMARY

A solid-state lithium-sulfur battery, especially a solid-state lithium metal-sulfur battery is relatively inferior in cycle characteristics to other lithium-ion batteries not using a sulfur-based positive electrode active material because its positive electrode active material layer remarkably expands and contracts during charging and discharging.

It is therefore an object of the present disclosure to improve cycle characteristics of a solid-state lithium-sulfur battery, especially of a solid-state lithium metal-sulfur battery.

The present disclosure achieves the above object by the following means.

### Aspect 1

A solid-state lithium-sulfur battery including a positive electrode current collector layer, a positive electrode active material layer, a solid electrolyte layer, and a negative electrode current collector layer in order of the positive electrode current collector layer, the positive electrode active material layer, the solid electrolyte layer, and the negative electrode current collector layer, wherein:
the positive electrode active material layer contains a sulfur-based active material, a solid electrolyte, and a resin binder that binds the sulfur-based active material and the solid electrolyte to each other;
the resin binder is butadiene rubber not containing fluorine; and
a content of the resin binder in the positive electrode active material layer is more than 0.0% by mass and 0.5% by mass or less.

### Aspect 2

The solid-state lithium-sulfur battery according to aspect 1, wherein the resin binder is an amine-group-introduced hydrogenated butadiene rubber, styrene-butadiene rubber, or a combination of amine-group-introduced hydrogenated butadiene rubber and styrene-butadiene rubber.

### Aspect 3

The solid-state lithium-sulfur battery according to aspect 1, wherein the resin binder is styrene-butadiene rubber.

### Aspect 4

The solid-state lithium-sulfur battery according to any one of aspects 1 to 3, wherein at least part of the solid electrolyte is a solid electrolyte self-generated during initial charging of the solid-state lithium-sulfur battery.

### Aspect 5

The solid-state lithium-sulfur battery according to any one of aspects 1 to 4, wherein the solid-state lithium-sulfur battery includes, in a charge state, the positive electrode current collector layer, the positive electrode active material layer, the solid electrolyte layer, a metallic lithium layer, and the negative electrode current collector layer in order of the positive electrode current collector layer, the positive electrode active material layer, the solid electrolyte layer, the metallic lithium layer, and the negative electrode current collector layer.

The solid-state lithium-sulfur battery, especially the solid-state lithium metal-sulfur battery of the present disclosure can have relatively excellent cycle characteristics in spite of the fact that a sulfur-based positive electrode active material is used as a positive electrode active material.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram for illustrating a solid-state lithium-sulfur battery of the present disclosure.

### DETAILED DESCRIPTION OF EMBODIMENTS

Hereinbelow, embodiments of the present disclosure will be described in detail. It should be noted that the present disclosure is not limited to the following embodiments and may be embodied with various changes and modifications within the scope thereof.

### Solid-State Lithium-Sulfur Battery

A solid-state lithium-sulfur battery of the present disclosure includes a positive electrode current collector layer, a positive electrode active material layer, a solid electrolyte layer, and a negative electrode current collector layer in this order. In the solid-state lithium-sulfur battery of the present disclosure, the positive electrode active material layer contains a sulfur-based active material, a solid electrolyte, and a resin binder that binds them to each other, the resin binder is butadiene rubber not containing fluorine, and the content of the resin binder in the positive electrode active material layer is more than 0% by mass and 0.5% by mass or less.

Such a solid-state lithium-sulfur battery, especially such a solid-state lithium metal-sulfur battery of the present disclosure can have relatively excellent cycle characteristics in spite of the fact that a sulfur-based positive electrode active material is used as a positive electrode active material.

Without intending to be limited by theory, the reason why relatively excellent cycle characteristics can be provided is considered to be that when the positive electrode active material layer contains, as a resin binder, only a small amount of butadiene rubber not containing fluorine, the binder is likely to deform in response to expansion and contraction of the positive electrode active material layer during charging and discharging of the solid-state lithium-sulfur battery. On the other hand, when the content of the resin binder is relatively large, it is considered that the binder is less likely to deform in response to expansion and contraction due to formation of relatively large agglomerates of the binder, and therefore the binder is likely to be detached from the sulfur-based active material and the solid electrolyte.

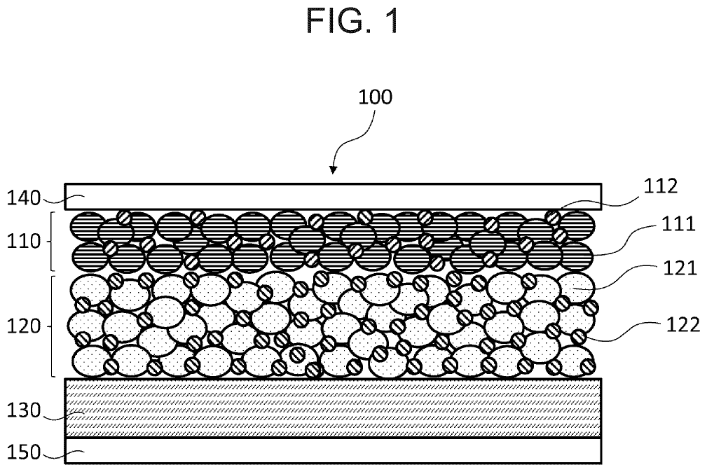

Specifically, as shown in FIG. 1, a solid-state lithium-sulfur battery 100 of the present disclosure includes, for example, a positive electrode current collector layer 140, a positive electrode active material layer 110, a solid electrolyte layer 120, and a negative electrode current collector layer 150 in this order. Particularly, when the solid-state lithium-sulfur battery of the present disclosure is a solid-state lithium metal-sulfur battery, that is a solid-state lithium-sulfur battery in which a metallic lithium deposition and dissolution reaction occurs at a negative electrode during charging and discharging, the solid-state lithium metal-sulfur battery 100 of the present disclosure includes, in a charge state, the positive electrode current collector layer 140, the positive electrode active material layer 110, the solid electrolyte layer 120, a metallic lithium layer 130, and the negative electrode current collector layer 150 in this order.

The positive electrode active material layer 110 contains a sulfur-based active material 111, a solid electrolyte (not shown), and a resin binder 112 that binds them to each other.

The solid electrolyte layer 120 can contain a solid electrolyte 121 and a resin binder 122 that binds particles of the solid electrolyte 121 to each other.

The metallic lithium layer 130 contains metallic lithium. During discharging of the solid-state battery 100, the metallic lithium in the metallic lithium layer 130 is ionized to generate lithium ions, and the lithium ions move through the solid electrolyte layer 120 and are occluded in the positive electrode active material layer 110. During charging of the solid-state battery 100, the lithium ions are released from the positive electrode active material layer 110, and metallic lithium is deposited between the solid 20 electrolyte layer 120 and the negative electrode current collector layer 150 to form the metallic lithium layer 130.

It should be noted that in the present disclosure, the “solid-state battery” means a battery using at least a solid electrolyte as an electrolyte, and therefore, the solid-state battery may use, as an electrolyte, a solid electrolyte and a liquid electrolyte in combination. Further, in the present disclosure, the “solid-state battery” may be an all-solid-state battery, that is, a battery using only a solid electrolyte as an electrolyte.

### Positive Electrode Current Collector Layer

The form of the positive electrode current collector layer is not limited, and the positive electrode current collector layer may be in the form of, for example, a foil or a plate. The positive electrode current collector layer may be constituted from a plurality of foils or layers. The positive electrode current collector layer may have a metallic foil or may have a layer formed of a resin composition containing a resin and a conductive additive.

A metal constituting the metallic foil may be at least one selected from among Cu, Ni, Cr, Au, Pt, Ag, Al, Fe, Ti, Zn, Co, V, Mg, Pb, Ge, In, Sn, Zr, and stainless steel. Particularly, from the viewpoint of, for example, oxidation resistance, the metallic foil preferably contains Al. The positive electrode current collector layer may be one obtained by plating a metallic foil or a base material with the above-mentioned metal or by evaporating the above-mentioned metal onto a metallic foil or a base material.

The thickness of the positive electrode current collector layer is not limited and may be 0.1 μm or more or 1 μm or more and 1 mm or less or 100 μm or less.

### Positive Electrode Active Material Layer

The positive electrode active material layer contains a sulfur-based active material, a solid electrolyte, and a resin binder that binds them to each other. The positive electrode active material layer may further contain another active material, a conductive additive, etc.

The form of the positive electrode active material layer is not limited, and the positive electrode active material layer may be in the form of, for example, a sheet having a substantially flat surface. The thickness of the positive electrode active material layer is not limited and may be, for example, 0.1 μm or more, 1 μm or more, or 10 μm or more and 2 mm or less, 1 mm or less, or 500 μm or less.

### Sulfur-Based Active Material

The sulfur-based active material contained in the positive electrode active material layer is not limited as long as it can react with lithium ions, which are charge compensation ions, during discharging to form a compound containing sulfur and lithium (e.g., a sulfide such as Li₂S) as a discharge product and can release lithium ions during charging.

The sulfide-based active material may be one containing elemental sulfur or one composed of elemental sulfur. The elemental sulfur may be octasulfur (S₈) or one other than that. The octasulfur (S₈) may be α-sulfur, β-sulfur, γ-sulfur, or a combination of two or more of them.

The sulfur-based active material may be a solid solution with a solid electrolyte or may be chemically bonded to a solid electrolyte. For example, when the solid electrolyte is a sulfide containing phosphorus, such as diphosphorus pentasulfide (P₂S₅), sulfur in the sulfur-based active material and sulfur in the phosphorus-containing sulfide may be chemically bonded.

The form of the sulfur-based active material is not limited, and the sulfur-based active material may be, for example, particulate. The particle diameter of the sulfur-based active material may be, for example, 1 nm or more, 5 nm or more, or 10 nm or more and 500 μm or less, 100 μm or less, 50 μm or less, or 30 μm or less. It should be noted that the particle diameter of the positive electrode active material is a particle diameter (median diameter) at a cumulative value of 50% in a volume-based particle size distribution determined by a laser diffraction/scattering method.

Whether or not the positive electrode active material layer contains a sulfur-based active material can be determined by performing various analyses such as XAFS, XRD, and NMR on a mixture constituting the positive electrode active material layer. For example, when the positive electrode active material layer is formed of a mixture containing elemental sulfur and the mixture is analyzed using a CuKα radiation source to obtain an X-ray diffraction pattern, diffraction peaks derived from elemental sulfur are observed in the X-ray diffraction pattern. The diffraction peaks derived from elemental sulfur typically appear at 2θ=23.05°±0.50°, 25.84°±0.50°, and 27.70°±0.50°.

The content of the sulfur-based active material in the positive electrode active material layer may appropriately be set depending on desired battery performance. For example, the content of the sulfur-based active material in the positive electrode active material layer may be 10% by mass or more, 20% by mass or more, 30% by mass or more, 40% by mass or more, 50% by mass or more, or 60% by mass or more and 100% by mass or less or 90% by mass or less.

### Solid Electrolyte

The solid electrolyte may be an inorganic solid electrolyte or an organic polymer electrolyte. Particularly, the inorganic solid electrolyte is excellent in ion conductivity and heat resistance. Examples of the inorganic solid electrolyte include an oxide solid electrolyte, a sulfide solid electrolyte, and an ion-binding inorganic solid electrolyte. Among these inorganic solid electrolytes, a sulfide solid electrolyte, especially a sulfide solid electrolyte containing at least Li, S, and P as constituent elements has high performance. Also, among these inorganic solid electrolytes, an ion-binding solid electrolyte, especially a solid electrolyte containing at least Li, Y, and a halogen (at least one of Cl, Br, I, and F) as constituent elements has high performance. The solid electrolyte may be amorphous or crystalline.

The particle diameter of the solid electrolyte may be 1.0 μm or less, 0.9 μm or less, 0.8 μm or less, 0.7 μm or less, or 0.5 μm or less and 0.1 μm or more, 0.2 μm or more, or 0.3 μm or more. The particle diameter of the solid electrolyte is a particle diameter (median diameter) at a cumulative value of 50% in a volume-based particle size distribution determined by a laser diffraction/scattering method.

The oxide solid electrolyte may be at least one selected from among lithium lanthanum zirconate, LiPON, Li₁₊ₓAlₓGe₂₋ₓ(PO₄)₃, Li—SiO-based glass, Li—Al—S—O-based glass. When the oxide solid electrolyte and a liquid electrolyte are used in combination, ion conductivity may be improved.

The sulfide solid electrolyte may be, for example, one containing an Li element, an X element (X is at least one of P, As, Sb, Si, Ge, Sn, B, Al, Ga, and In), and an S element. The sulfide solid electrolyte may further contain at least one of an O element and a halogen element. The sulfide solid electrolyte may be one containing an S element as a main component of an anionic element.

The sulfide solid electrolyte may be, for example, at least one selected from among Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (wherein m and n are positive values and Z is any one of Ge, Zn, and Ga), Li₂S—GeS₂, Li₂S—SiS₂—Li₃PO₄, and Li₂S—SiS₂-LiₓMO_{y} (wherein x and y are positive values and M is any one of P, Si, Ge, B, Al, Ga, and In).

In the solid-state lithium-sulfur battery of the present disclosure, at least part of the solid electrolyte may be one self-generated during initial charging of the solid-state lithium-sulfur battery. Specifically, the solid-state lithium-sulfur battery of the present disclosure contains a phosphorus-containing sulfide, e.g., P₂S₅ before initial charging, and at least part of the phosphorous-containing sulfide can react with lithium during initial charging to generate such a sulfide solid electrolyte as described above. The thus self-generated solid electrolyte during initial charging is preferred because an appropriate ion-conducting network can be provided.

Here, the phosphorus-containing sulfide may be one containing at least phosphorus and sulfur and further containing another element as constituent elements. The other element may be, for example, one or two or more of Ge, Sn, Si, B, and Al. The phosphorus-containing sulfide contains, as constituent elements, phosphorus, sulfur, and such another element as mentioned above, but does not have to contain lithium. The phosphorus-containing sulfide may be, for example, P₂S₅. The phosphorus-containing sulfide may be one having the ortho-structure of a phosphorus element (PS₄ structure). The form of the phosphorus-containing sulfide is not limited, and the phosphorus-containing sulfide may be, for example, particulate. Whether or not the positive electrode active material layer before initial charging contains a phosphorus-containing sulfide can be determined by performing various analyses such as XAFS, XRD, and NMR on the positive electrode active material layer.

### Binder

In the solid-state lithium-sulfur battery of the present disclosure, the resin binder is butadiene rubber not containing fluorine, especially amine-group-introduced hydrogenated butadiene rubber, styrene-butadiene rubber, or a combination of amine-group-introduced hydrogenated butadiene rubber and styrene-butadiene rubber, more especially styrene-butadiene rubber.

The amine-group-introduced hydrogenated butadiene rubber is one obtained by introducing an amine group to the end of hydrogenated butadiene rubber. Here, the hydrogenated butadiene rubber is a resin obtained by hydrogenating some or all of the unsaturated bonds of butadiene rubber, and has relatively high flexibility. The amine-group-introduced hydrogenated butadiene rubber has an amino group introduced thereto as a polar group and therefore has improved bonding strength with a solid electrolyte. The styrene-butadiene rubber may or may not be hydrogenated.

The content of the resin binder in the positive electrode active material layer is more than 0.0% by mass and 0.5% by mass or less. The content may be 0.1% by mass or more or 0.2% by mass or more and 0.4% by mass or less.

### Active Material Other Than Sulfur-Based Active Material

The active material other than the sulfur-based active material may be, for example, any of various lithium-containing compounds. The lithium-containing compounds may be various lithium-containing oxides such as lithium cobalt oxide, lithium nickel oxide, Li_{1±α}Ni_{1/3}Co_{1/3}Mn_{1/3}O_{2±δ}, lithium manganese oxide, spinel-based lithium compounds (e.g., Li—Mn spinel substituted with different elements having a composition represented by Li₁₊ₓMn_{2-x-y}M_{y}O₄ (M is at least one selected from among Al, Mg, Co, Fe, Ni, and Zn)), lithium titanate, and lithium metal phosphate (e.g., LiMPO₄, M is at least one selected from among Fe, Mn, Co, and Ni). It should be noted that when the ratio of the sulfur-based active material to the entire positive electrode active material is higher, the positive electrode active material layer is likely to more greatly expand and contract during charging and discharging.

### Conductive Additive

The conductive additive is not limited and may be, for example, carbon. Examples of the carbon include carbon nanotubes, vapor-grown carbon fiber (VGCF), acetylene black, furnace black, ketjen black, activated carbon, and graphene, and these may be used singly or in combination of two or more of them. Particularly, when the positive electrode active material layer contains carbon nanotubes, high battery performance is likely to be achieved. Examples of another conductive additive include conductive additives made of various metallic materials, and these may be used singly or in combination of two or more of them. The conductive additive may be, for example, particulate or fibrous, and the size thereof is not limited.

### Method for Producing Positive Electrode Active Material Layer

The positive electrode active material layer can be produced through the application of a publicly-known method. For example, the positive electrode active material layer can be formed by shaping a positive electrode mixture containing the above-described various components in a dry or wet manner. The positive electrode active material layer may be shaped on the positive electrode current collector layer or may be shaped separately from the positive electrode current collector layer.

### Solid Electrolyte Layer

The solid electrolyte layer contains a solid electrolyte and optionally contains a resin binder. The resin binder used here is not limited and may be, for example, one or two or more selected from among butadiene rubber, butylene rubber, acrylate-butadiene rubber, styrene-butadiene rubber, polyvinylidene fluoride, polytetrafluoroethylene, and polyimide. The resin binder used here may be one described above with reference to the positive electrode active material layer.

The content of the resin binder in the solid electrolyte layer may be 5% by mass or more and 15% by mass or less. When the content of the resin binder in the solid electrolyte layer is higher, the solid electrolyte has higher flexibility, but battery performance reduces. The content may be 6% by mass or more, 7% by mass or more, 8% by mass or more, 9% by mass or more, or 10% by mass or more and 15% by mass or less, 14% by mass or less, 13% by mass or less, 12% by mass or less, or 11% by mass or less.

The content of the solid electrolyte is not limited and may appropriately be set depending on, for example, the intended use and performance of a thin film for a solid-state battery. The content of the solid electrolyte may be, for example, 1% by mass or more, 5% by mass or more, 10% by mass or more, 15% by mass or more, or 20% by mass or more and 95% by mass or less, 90% by mass or less, 80% by mass or less, 70% by mass or less, 60% by mass or less, or 50% by mass or less relative to the solid electrolyte layer.

The solid electrolyte layer may be constituted from one layer or a plurality of layers. For example, the solid electrolyte layer may include a first layer disposed on the positive electrode side and a second layer disposed on the negative electrode side, and in this case, the first layer may contain a first solid electrolyte and the second layer may contain a second sold electrolyte. The first solid electrolyte and the second solid electrolyte may be different from each other. Each of the first solid electrolyte and the second solid electrolyte may be at least one selected from among an oxide solid electrolyte, a sulfide solid electrolyte, and an ion-binding solid electrolyte which will be described later. For example, the first layer may contain an ion-binding solid electrolyte and the second layer may contain at least one of an ion-binding solid electrolyte and a sulfide solid electrolyte.

The form of the solid electrolyte layer is not limited, and the solid electrolyte layer may be in the form of, for example, a sheet having a substantially flat surface. The thickness of the solid electrolyte layer is not limited and may be, for example, 0.1 μm or more, 1 μm or more, or 10 μm or more and 2 mm or less, 1 mm or less, or 500 μm or less.

### Method for Producing Solid Electrolyte Layer

The solid electrolyte layer can be formed by, for example, shaping a solid electrolyte mixture containing the above-described solid electrolyte and resin binder in a dry or wet manner.

### Metallic Lithium Layer

The metallic lithium layer takes a role as a negative electrode active material layer. The metallic lithium layer is composed of metallic lithium. The “metallic lithium” may be elemental lithium or a lithium alloy.

In a charge state, lithium ions that have moved from the positive electrode receive electrons and are deposited as metallic lithium or an alloy with another metal to form a metallic lithium layer between the electrolyte layer and the negative electrode current collector layer. In a discharge state, lithium in the negative electrode layer is ionized and moves back to the positive electrode layer.

The amount of metallic lithium to be deposited in a charge state is not limited and may appropriately be set depending on desired battery performance. However, if the amount of metallic lithium to be deposited is too large, for example, there is a fear of stress concentration. The amount of metallic lithium to be deposited may be set such that the battery has a charge capacity of, for example, 1 mAh/cm² or more and 5 mAh/cm² or less.

The form of the metallic lithium layer is not limited, and the metallic lithium layer may be in the form of, for example, a sheet having a substantially flat surface. The thickness of the metallic lithium layer is not limited and may be, for example, 0.1 μm or more, 1 μm or more, or 10 μm or more and 2 mm or less, 1 mm or less, or 500 μm or less.

The lithium alloy is not limited and may be, for example, Li—Mg, Li—Sn, Li—Al, Li—B, Li—C, Li—Si, Li—Ca, Li—Ga, Li—Ge, Li—As, Li—Se, Li—Ru, Li—Rh, Li—Pd, Li—Ag, Li—Au, Li—Cd, Li—In, Li—Sb, Li—Ir, Li—Pt, Li—Hg, Li—Pb, Li—Bi, Li—Zn, Li-TI, Li—Te, or Li—At. The lithium alloy may include only one type of lithium alloy or two or more types of lithium alloys.

### Negative Electrode Current Collector Layer

The negative electrode current collector layer may be a metallic foil or a metallic mesh or may be a carbon sheet. Particularly, from the viewpoint of handleability, a metallic foil is preferred. The negative electrode current collector layer may be constituted from a plurality of metallic foils or sheets. When the negative electrode current collector layer is constituted from a plurality of metallic foils or sheets, a layer of some kind may be interposed between the metallic foils.

Examples of a metal constituting the metallic foil include Cu, Ni, Cr, Au, Pt, Ag, Al, Fe, Ti, Zn, Co, and stainless steel. Particularly, from the viewpoint of reduction resistance and the viewpoint that alloying with lithium is less likely to occur, the metallic foil preferably contains at least one selected from among Cu, Ni, and stainless steel, especially at least one of Ni and stainless steel.

The negative electrode current collector layer may have any coating layer on the surface thereof. For example, the negative electrode current collector layer may have any protective layer on the surface thereof. The protective layer may be, for example, one containing Mg. When the negative electrode current collector layer has a protective layer containing Mg, it is considered that diffusion of Li in the surface of the negative electrode current collector layer is promoted, and in addition, a gap between the negative electrode current collector layer and metallic lithium is reduced due to enhanced affinity of metallic lithium for the negative electrode current collector layer, and therefore metallic lithium is more evenly deposited on the surface of the negative electrode current collector layer.

The thickness of the negative electrode current collector layer is not limited, and may be 0.1 μm or more or 1 μm or more and 1 mm or less or 100 μm or less.

### Method for Producing Solid-State Lithium-Sulfur Battery

The solid-state lithium-sulfur battery of the present disclosure can be produced by a publicly-known method. Specifically, a method for producing the solid-state battery of the present disclosure may include, for example, S1: forming a positive electrode active material layer on a positive electrode current collector layer, S2: obtaining a laminated body including the positive electrode current collector layer, the positive electrode active material layer, a solid electrolyte layer, a metallic lithium layer, and a negative electrode current collector layer in this order, and S3: housing the laminated body in an exterior body.

In the step S1, a positive electrode active material layer may be formed on a positive electrode current collector layer by applying a positive electrode mixture slurry, which is obtained by dispersing a sulfur-based active material or the like constituting the positive electrode active material layer in a solvent, onto the positive electrode current collector layer using a doctor blade or the like and then by drying the positive electrode mixture slurry. The solvent used in this case is not limited and may be any of various organic solvents.

In the step S2, a laminated body including a negative electrode current collector layer, a metallic lithium layer, a solid electrolyte layer, the positive electrode active material layer, and the positive electrode current collector layer in this order may be obtained by laminating the respective layers in such a manner that the solid electrolyte layer is sandwiched between the metallic lithium layer and the positive electrode active material layer. If necessary, another member such as a terminal may be attached to the laminated body.

In the step S3, a solid-state battery may be obtained by housing the laminated body in a battery case, filling the battery case with an electrolytic solution when a liquid electrolyte is used, and hermetically sealing the laminated body in the battery case.

### Example 1

The present disclosure will specifically be described with reference to examples and comparative examples, but the present disclosure is not limited to these examples.

In the following examples and comparative examples, solid-state lithium metal-sulfur batteries having the following laminate configuration were produced and evaluated: surface-roughened aluminum foil/positive electrode active material layer/sulfide solid electrolyte (0.5 μm)/Li-10 wt % Mg alloy foil (100 μm)/surface-roughened nickel foil.

Specifically, the solid-state lithium metal-sulfur batteries of examples and comparative examples were produced in the following manner. The details of the solid-state lithium metal-sulfur batteries of examples and comparative examples are shown below in Table 1.

### 1. Production of Positive Electrode Active Material Layer

Sulfur (vacuum-dried product at 80° C.) as a positive electrode active material, P₂S₅ as a solid electrolyte precursor, Li₃PS₄ as a solid electrolyte, and single-layer carbon nanotubes (vacuum-dried product at 120° C.) were mixed in a weight ratio of 42:35:23 in a mortar, and 1.7 g of the mixture and 80 g of § 4-mm zirconia balls were placed in a ball mill pot and mixed with a planetary ball mill at 400 rpm for a total of 36 hours. After the ball mill mixing, dry classification was performed using a 38-μm sieve to obtain a sulfur positive electrode active material.

A positive electrode mixture slurry was produced by mixing the sulfur positive electrode active material and a resin binder in a mass ratio of sulfur positive electrode active material:resin binder of 99.7:0.3, 99.4:0.6, or 99.1:0.9 using, as a solvent, heptane which was used when the resin binder was amine-group-introduced hydrogenated butadiene rubber (ABR) or mesitylene which was used when the resin binder was styrene-butadiene rubber (SBR).

The obtained positive electrode mixture slurry was applied onto a surface-roughened aluminum foil at a coating gap of 220 μm and was then subjected to preliminary drying at 50° C. and then to final drying at 100° C. for 30 minutes to obtain a positive electrode mixture layer coated on the positive electrode current collector foil.

### 2. Production of Solid Electrolyte Layer

A solid electrolyte slurry was produced by mixing a solid electrolyte (particle diameter: 0.5 μm) and a resin binder in a mass ratio of 90.9:9.1 using heptane as a dispersion medium.

The obtained solid electrolyte slurry was applied onto a release film at a coating gap of 450 μm and was then subjected to preliminary drying at room temperature for about 3 hours and then to final drying at 165° C. for 1 hour to obtain a solid electrolyte layer.

The obtained solid electrolyte layer was punched into two disks having a diameter of 14.5 mm, and the disks were stacked in such a manner that their coated surfaces faced each other and were pressed at a pressure of 6 tons at room temperature. After the pressing, the release films were removed to obtain a freestanding sulfide solid electrolyte layer.

### 3. Production of Lamicell

The positive electrode layer produced above in “1. Production of Positive Electrode Active Material Layer” was punched into a disk having a diameter of 11.28 mm, an Li-10 wt % Mg alloy foil was punched into a disk having a diameter of 13.0 mm, and a surface-roughened nickel foil as a negative electrode current collector foil was punched into a disk having a diameter of 14.5 mm.

The thus obtained disk-shaped Li—Mg foil and disk-shaped surface-roughened nickel foil were stacked and bonded together by pressing at a pressure of 0.1 tons to obtain a disk-shaped negative electrode layer. The disk-shaped solid electrolyte sheet produced above in “2. Production of Solid Electrolyte Layer” was disposed between the disk-shaped positive electrode layer and the disk-shaped negative electrode layer. An aluminum foil as a positive electrode tab was joined to the positive electrode current collector, and a nickel foil as a negative electrode tab was joined to the negative electrode current collector. Then, the thus obtained solid-state lithium metal-sulfur battery was vacuum-sealed in a laminate film. The sealed cell was subjected to isostatic pressing at 300 MPa using a cold isostatic press (CIP) to produce a laminate cell.

### 4. Electrochemical Measurement

A constant-current charge/discharge test was performed at 60° C. under conditions of a cut-off voltage range of 3.1 V to 1.2 V and 1C=5.84 mA/cm² according to the following protocol.
Current density: 0.584 mA/cm² (corresponding to 0.1C)
Conditioning (cycle 0): discharge to 1.2 V
After conditioning (cycle 1~): charge to 3.1 V and discharge to 1.2 V

The evaluation results are shown below in Table 1.

TABLE 1

| | Production Conditions | | | | | |
|---|---|---|---|---|---|---|
| | Lithium Ion- | Type of | Resin Binder | | | |
| | Conducting | Resin | Content in | Evaluation Results | | |
| | Phase Self- | Binder of | Positive | Conditioning | Discharge | Discharge |
| | Generated in | Positive | Electrode | Discharge | Capacity | Capacity |
| | Positive | Electrode | Active | Capacity | after Cycle | after Cycle |
| | Electrode | Active | Material | [mAh/g | 1 [mAh/g | 10 [mAh/g |
| | Active | Material | Layer | (Negative | (Negative | (Negative |
| | Material Layer | Layer | [wt %] | Electrode)] | Electrode)] | Electrode)] |
| Example 1 | Present | ABR | 0.3 | 1144.8 | 912.5 | 373.7 |
| Comparative Example 1 | Present | ABR | 0.6 | 1052.1 | 363.2 | 35.4 |
| Comparative Example 2 | Present | ABR | 0.9 | 1047.0 | 329.9 | 22.4 |
| Example 2 | Present | SBR | 0.3 | 1017.9 | 816.3 | 734.7 |
| Comparative Example 3 | Present | SBR | 0.6 | 1107.7 | 556.3 | 74.2 |
| Comparative Example 4 | Present | SBR | 0.9 | 1097.6 | 218.7 | 5.0 |
| Example 3 | Absent | SBR | 0.3 | 685.2 | 679.3 | 628.5 |

As can be seen from Table 1 shown above, when the resin binder of the positive electrode active material layer is amine-group-introduced hydrogenated butadiene rubber (ABR), the solid-state lithium-sulfur battery of Example 1 whose resin binder content in the positive electrode active material layer is 0.3% by mass is superior in discharge capacity after cycle 1 and discharge capacity after cycle 10 to the solid-state lithium-sulfur battery of Comparative Example 1 whose resin binder content in the positive electrode active material layer is 0.6% by mass and the solid-state lithium-sulfur battery of Comparative Example 2 whose resin binder content in the positive electrode active material layer is 0.9% by mass.

Further, as can be seen from Table 1 shown above, when the resin binder of the positive electrode active material layer is styrene-butadiene rubber (SBR), the solid-state lithium-sulfur battery of Example 2 whose resin binder content in the positive electrode active material layer is 0.3% by mass is superior in discharge capacity after cycle 1 and discharge capacity after cycle 10 to the solid-state lithium-sulfur battery of Comparative Example 3 whose resin binder content in the positive electrode active material layer is 0.6% by mass and the solid-state lithium-sulfur battery of Comparative Example 4 whose resin binder content in the positive electrode active material layer is 0.9% by mass.

Further, as can be seen from Table 1 shown above, the solid-state lithium-sulfur battery of Example 2 which contains styrene butadiene rubber (SBR) as a resin binder in the positive electrode active material layer and whose resin binder content in the positive electrode active material layer is 0.3% by mass is superior in discharge capacity after cycle 1 and discharge capacity after cycle 10 to the solid-state lithium-sulfur battery of Example 1 which contains amine-group-introduced hydrogenated butadiene rubber (ABR) as a binder resin in the positive electrode active material layer and whose resin binder content in the positive electrode active material layer is 0.3% by mass.

Further, as can be seen from Table 1 shown above, when the resin binder of the positive electrode active material layer is styrene-butadiene rubber (SBR) and the resin binder content in the positive electrode active material layer is 0.3% by mass, the solid-state lithium-sulfur battery of Example 2 in which a lithium-ion conducting phase has been self-generated in the positive electrode active material layer is superior in discharge capacity after cycle 1 and discharge capacity after cycle 10 to the solid-state lithium-sulfur battery of Example 3 in which such a lithium-ion conducting phase has not been self-generated.

What is claimed is:

1. A solid-state lithium-sulfur battery comprising a positive electrode current collector layer, a positive electrode active material layer, a solid electrolyte layer, and a negative electrode current collector layer in order of the positive electrode current collector layer, the positive electrode active material layer, the solid electrolyte layer, and the negative electrode current collector layer, wherein:
the positive electrode active material layer contains a sulfur-based active material, a solid electrolyte, and a resin binder that binds the sulfur-based active material and the solid electrolyte to each other;
the resin binder is butadiene rubber not containing fluorine; and
a content of the resin binder in the positive electrode active material layer is more than 0.0% by mass and 0.5% by mass or less.

2. The solid-state lithium-sulfur battery according to claim 1, wherein the resin binder is amine-group-introduced hydrogenated butadiene rubber, styrene-butadiene rubber, or a combination of amine-group-introduced hydrogenated butadiene rubber and styrene-butadiene rubber.

3. The solid-state lithium-sulfur battery according to claim 1, wherein the resin binder is styrene-butadiene rubber.

4. The solid-state lithium-sulfur battery according to claim 1, wherein at least part of the solid electrolyte is a solid electrolyte self-generated during initial charging of the solid-state lithium-sulfur battery.

5. The solid-state lithium-sulfur battery according to claim 1, wherein the solid-state lithium-sulfur battery includes, in a charge state, the positive electrode current collector layer, the positive electrode active material layer, the solid electrolyte layer, a metallic lithium layer, and the negative electrode current collector layer in order of the positive electrode current collector layer, the positive electrode active material layer, the solid electrolyte layer, the metallic lithium layer, and the negative electrode current collector layer.
